(19) United States
(12) Patent Application Publication
(10) Pub. No.: US 2012/0095997 A1
(43) Pub. Date: Apr. 19, 2012

(54) PROVIDING CONTEXTUAL HINTS ASSOCIATED WITH A USER SESSION

(75) Inventors: NIR NICE, Kfar Veradim (IL); URI BARASH, Tel Mond (IL); SEFY OPHIR, Tel Mond (IL); ERAN SHAMIR, Alilt (IL); RON KARIDI, Herzeliya (IL); HADAR SHEMTOV, Palo Alto, CA (US); ANNA TIMASHEVA, Seattle, WA (US)

(73) Assignee: MICROSOFT CORPORATION, REDMOND, WA (US)

(21) Appl. No.: 12/906,763

(22) Filed: Oct. 18, 2010

(51) Int. Cl. G06F 17/30

(52) U.S. Cl. 707/728; 707/E17.083

(57) ABSTRACT

Systems, methods, and computer storage media having computer-executable instructions embodied thereon that provide contextual indicators associated with a user session are described. Content items within a document associated with a user session are selected. Upon receiving an indication that the user desires to perform a context-aware search, the document associated with the user session is analyzed for contextual information related to the content items selected by the user. Various “contextual indicators” associated with the user session are derived. The contextual indicators are provided for output in association with the user session. The contextual indicators may be fed to a search engine and used to identify search results that the user has an increased likelihood (relative to the current context surrounding the user) of desiring to access.

### BACKGROUND

Computing device users commonly submit search queries to locate information related to a topic of interest. Typically, search engines allow users to search for information by entering a search query comprising one or more keywords that may be of interest to the user. After receiving a search request from a user, a search engine identifies a variety of content (e.g., documents, web pages, files, etc.) that are relevant based on the keywords in the search query. Unfortunately, search engines often return search results that include a large number of documents or web pages, many of which have little or nothing to do with the specific information that the user was seeking. As a result, the data a user is looking for is either not found or is buried in a result set that is too large for the user to quickly navigate. The user is then left to sift through the list of documents, links, and associated information to find the desired information and/or modify the search using additional keywords.

The problem of irrelevant search results is often exacerbated when the search query contains ambiguous keywords. For instance, a particular user planning a trip to South America may conduct a search for “amazon” to view information related to the rainforest only to be bombarded with results related to the electronic commerce company. Search engines have implemented a variety of techniques and algorithms to attempt to refine searches and present the most relevant search results. Typically, such techniques are aimed at providing search results that are relevant to the search query itself, but often fail to provide results that are highly relevant to the user in situations where the search query keywords are ambiguous.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Embodiments of the present invention relate to systems, methods, and computer-readable media for, among other things providing contextual indicators associated with a user session. Various aspects of the technology described herein are generally directed to performing a context-aware search using contextual indicators associated with a user session. A user session is limited to a current activity of the user, such as a user interacting with a particular application. A document is typically associated with the current user application, for instance, an email conversation may be associated with a user session involving a personal information management software application. An indication that a user has selected content items within the document associated with the current user session is received. Upon receiving an indication that the user desires to perform a context-aware search, for instance, upon receiving an indication that a context-aware search icon has been selected, the document associated with the current user application is analyzed for contextual information related to the content items selected by the user.

Various “contextual indicators” associated with the user session are derived, the contextual indicators being keywords that best represent contents of the document of the user session. The contextual indicators are provided for output in association with the user session, for instance, the contextual indicators may be fed to a search engine and used to identify search results that the user has an increased likelihood (relative to the current context surrounding the user) of desiring to access. The contextual indicators may be utilized to rank the search results for contextual relevance relative to the current context surrounding the user initiating the context-aware search.

### BRIEF DESCRIPTION OF THE DRAWINGS

The present invention is illustrated by way of example and not limited in the accompanying figures in which like reference numerals indicate similar elements and in which:

FIG. 1 is a block diagram of an exemplary computing system environment suitable for use in implementing embodiments of the present invention;

FIG. 2 is a block diagram of an exemplary system according to an embodiment of the present invention;

FIG. 3 is a flow diagram of an exemplary method of providing contextual indicators associated with a user session, according to an embodiment of the present invention;

FIG. 4 is a flow diagram of another exemplary method of providing contextual indicators associated with a user session, according to an embodiment of the present invention;

FIG. 5 is a flow diagram of an exemplary method of performing a context-aware search using contextual indicators associated with a user session, according to an embodiment of the present invention; and

FIG. 6 is a line drawn representation of a graphical image depicting contextual indicators derived in a user session in accordance with an embodiment of the present invention.

### DETAILED DESCRIPTION

The subject matter of the present invention is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

Various aspects of the technology described herein are generally directed to systems, methods, and computer-readable media for, among other things, providing contextual indicators associated with a user session. Systems, methods, and computer-readable media for, performing a context-aware search using contextual indicators associated with a user session are also described. Within a user session, a user may interact with various applications. As used herein, a user session is limited to a current activity of the user. A file or document may be associated with the current user application, for instance, an email conversation may be associated with a user session involving a personal information management software application. An indication that a user has selected content items within the document associated with the current user session is received. Upon receiving an indication that the user desires to perform a context-aware search, for instance, upon receiving an indication that a context-aware search icon has been selected, the document associated with the current user application is analyzed for contextual information related to the content items selected by the user. Various “contextual indicators” associated with the user session are derived, the contextual indicators being keywords that best represent content of the document of the user session. The contextual indicators are provided for output in association with the user session, for instance, the contextual indicators may be fed to a search engine and used to identify search results that the user has an increased likelihood (relative to the current context surrounding the user) of desiring to access. The contextual indicators may be utilized to rank the search results for contextual relevance relative to the current context surrounding the user initiating a context-aware search.

Accordingly, in one aspect, the present invention is directed to one or more computer storage media having computer-executable instructions embodied thereon, that when executed, cause a computing device to perform a method for providing contextual indicators associated with a user session. The method includes, receiving an indication that one or more content items have been selected within a user session, the user session being an in progress encounter between a user and at least one application, and receiving an indication that a context-aware search based on the one or more selected content items has been requested within the user session. The method further includes analyzing at least one document associated with the user session for contextual information related to the one or more selected content items and deriving one or more contextual indicators from the at least one document, the one or more contextual indicators being keywords that represent relevant content of the at least one document associated with the user session. The method further includes providing the one or more derived contextual indicators for output in association with the user session of the computing device generating a context-aware search request.

In another aspect, the present invention is directed to one or more computer storage media having computer-executable instructions embodied thereon, that when executed, cause a computing device to perform a method for performing a context-aware search using contextual indicators associated with a user session. The method includes receiving a search query, and receiving one or more contextual indicators derived from a user session from which the search query has been initiated, the user session being an in progress encounter between a user and at least one application. The contextual indicators comprise keywords that represent relevant content of at least one document associated with the user session. The method further includes determining a set of search results based on the search query and determining for at least one search result a contextual relevance by comparing the at least one search result to at least a portion of the one or more contextual indicators derived from the user session from which the search query has been initiated.

In yet another aspect, the present invention is directed to a computerized system for performing a context-aware search using contextual indicators associated with a user session, the system includes a processing unit; and a memory for storing computer-executable instructions that when executed by the processing unit executes: a context-aware search selector component configured to provide an indication that the context-aware search has been requested within the user session. The system also includes a context analyzer component configured to analyze at least one document associated with the user session for contextual information and to derive one or more contextual indicators from the at least one document. Contextual indicators are keywords that represent relevant content of the at least one document associated with the user session. The system further includes, a searching component configured to perform a search in response to a search query by indentifying at least one content item matching the search query, and a relevance component configured to determine for the at least one content item matching the search query a contextual relevance to the user requesting the search. Contextual relevance is determined by ranking the at least one content item matching the search query utilizing the one or more contextual indicators associated with the user session. The system also includes a delivery component configured to provide search results having a contextual relevance above a pre-determined threshold to the user requesting the search within the user session.

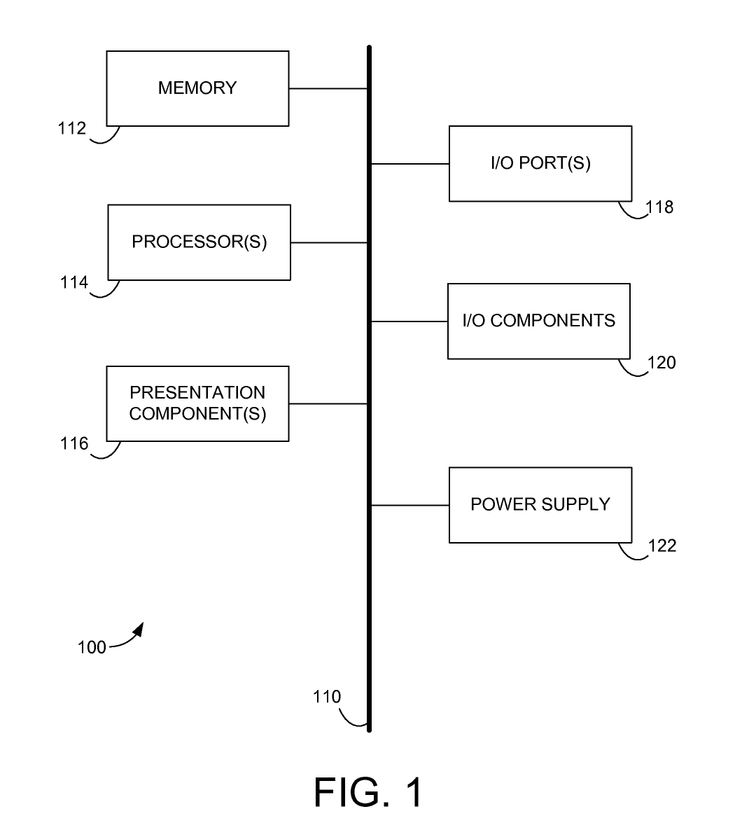

Having briefly described embodiments of the present invention, now described is FIG. 1 in which an exemplary operating environment for implementing embodiments of the present invention is shown and designated generally as computing device 100. Computing device 100 is but one example of a suitable computing environment and is not intended to suggest any limitation as to the scope of use or functionality of invention embodiments. Neither should the computing device 100 be interpreted as having any dependency or requirement relating to any one or combination of components illustrated.

Embodiments of the invention might be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. Embodiments of the invention might be practiced in a variety of system configurations, including handheld devices, consumer electronics, general-purpose computers, more specialty computing devices, etc. Embodiments of the invention might also be practiced in distributed computing environments where tasks are performed by remote-processing devices that are linked through a communications network.

With reference to FIG. 1, computing device 100 includes a bus 110 that directly or indirectly couples the following devices: memory 112, one or more processors 114, one or more presentation components 116, input/output ports 118, input/output components 120, and a power supply 122. Bus 110 represents what might be one or more busses (such as an address bus, data bus, or combination thereof). Although the various blocks of FIG. 1 are shown with lines for the sake of clarity, in reality, delineating various components is not so clear, and metaphorically, the lines would more accurately be grey and fuzzy. For example, one may consider a presentation component such as a display device to be an I/O component. Also, processors have memory. We recognize that such is the nature of the art and reiterate that the diagram of FIG. 1 is merely illustrative of an exemplary computing device that can be used in connection with one or more embodiments of the present invention. Distinction is not made between such categories as “workstation,” “server,” “laptop,” “handheld device,” etc., as all are contemplated within the scope of FIG. 1 and reference to “computing device.”

Computing device 100 typically includes a variety of computer-readable media. By way of example, computer-readable media may comprises Random Access Memory (RAM); Read Only Memory (ROM); Electronically Erasable Programmable Read Only Memory (EEPROM); flash memory or other memory technologies; CDROM, digital versatile disks (DVD) or other optical or holographic media; magnetic cassettes, magnetic tape, magnetic disk storage or other magnetic storage devices, carrier wave or any other medium that can be used to encode desired information and be accessed by computing device 100.

Memory 112 includes computer-storage media in the form of volatile and/or nonvolatile memory. The memory may be removable, nonremovable, or a combination thereof. Exemplary hardware devices include solid-state memory, hard drives, optical-disc drives, etc. Computing device 100 includes one or more processors 114 that read data from various entities such as memory 112 or I/O components 120. Presentation component(s) 116 present data indications to a user or other device. Exemplary presentation components include a display device, speaker, printing component, vibrating component, etc.

I/O ports 118 allow computing device 100 to be logically coupled to other devices including I/O components 120, some of which may be built in. Illustrative components include a microphone, joystick, game pad, satellite dish, scanner, printer, wireless device, etc.

Embodiments of the present invention might be embodied as, among other things: a method, system, or set of instructions embodied on one or more computer-readable media. Computer-readable media include both volatile and nonvolatile media, removable and nonremovable media, and contemplates media readable by a database, a switch, and various other network devices. By way of example, computer-readable media comprise media implemented in any method or technology for storing information. Examples of stored information include computer-useable instructions, data structures, program modules, and other data representations. Media examples include, but are not limited to information-delivery media, RAM, ROM, EEPROM, flash memory or other memory technology, CD-ROM, digital versatile discs (DVD), holographic media or other optical disc storage, magnetic cassettes, magnetic tape, magnetic disk storage, and other magnetic storage devices. These technologies can store data momentarily, temporarily, or permanently.

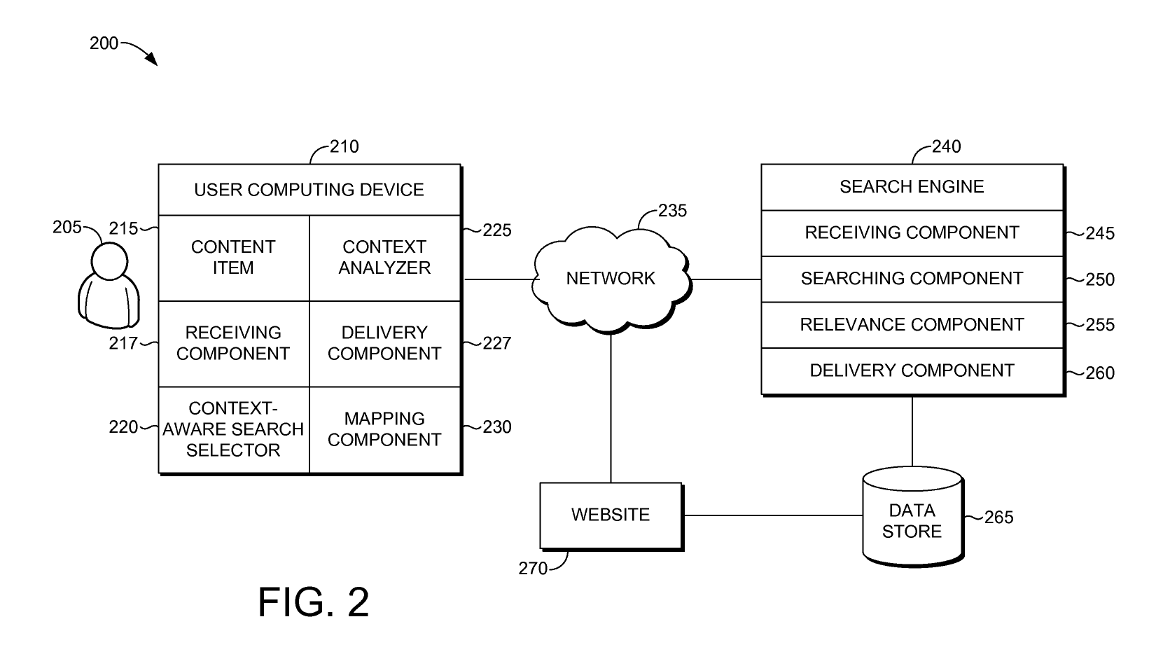

Turning now to FIG. 2, a block diagram is illustrated, in accordance with an embodiment of the present invention, showing a system 200 configured to perform a context-aware search using contextual indicators associated with a user session. It will be understood and appreciated by those of ordinary skill in the art that the system 200 shown in FIG. 2 is merely an example of one suitable computing system environment and is not intended to suggest any limitation as to the scope of use or functionality of embodiments of the present invention. Neither should the system 200 be interpreted as having any dependency or requirement related to any single component or combination of components illustrated therein. Further, the system 200 may be provided as a stand-alone product, as part of a software development environment, or any combination thereof.

The system 200 includes one or more user computing devices 210, a search engine server 240, one or more websites 270, and one or more data stores 265, all in communication with one another. Generally, components (e.g., context-aware search selector 220, content analyzer 225, receiving component 245, and delivery component 260) of the exemplary system 200 may be interconnected by any method known in the relevant field. In embodiments, a network 235 is provided to facilitate communication between the computing devices 210, components of search engine 240 and websites 270. The network 235 may be wireless and may include, without limitation, one or more local area networks (LANs) and/or wide area networks (WANs). Such networking environments are commonplace in offices, enterprise-wide computer networks, intranets, and the Internet. The network 235 may also include private and public local networks, and wireless data or telephone networks. In addition, many more components (e.g., BTSs, devices, and the like) may be operably coupled to network 235.

The user computing device 210 is any computing device, such as the computing device 100, that allows a user 205 to interact with one or more applications in a user session. For example, the user computing device 210 might be a personal computer, a laptop, a server computer, a wireless phone or device, a personal digital assistant (PDA), among others. Additionally, the computing devices 210 may further include a keyboard, keypad, stylus, joystick, and any other input-initiating component that allows a user to access wired or wireless data on the network 235. It should be noted, however, that the present invention is not limited to implementation on such computing devices, but may be implemented on any of a variety of different types of computing devices within the scope of embodiments hereof. In an embodiment, a plurality of user devices 210, such as thousands or millions of user computing devices 210 are connected to the network.

In an embodiment of the present invention, contextual indicators are derived from a user session on user computing device 210 and sent to search engine 240 via network 235. Contextual indicators are indicators of the environment of a particular user session. Contextual indicators may include, by way of example only, keywords that represent the main content of a particular document associated with a user session. The user session may be defined by a current activity of the user, for instance, where a user 205 reviewing the data of a spreadsheet document switches activities to editing a word processing document, the word processing document would be associated with a current user session. In other instances, the user session may involve multiple activities of a user, for instance, a user session may include the last three documents utilized by a user. The user computing device 210 may include several components utilized in deriving contextual indicators and requesting a context-aware search. In an embodiment of the present invention, user computing device 210 may include several content items 215, a context-aware search selector 220, a context analyzer 225 and a mapping component 230. Content items 215 include items associated with the various applications on the user computing device 210. During a user session, user 205 may interact with one of various applications and their associated files or documents. For example, user 205 may interact with content items 215 that include the documents of a user session such as, a word processing document, an electronic mail message, an instant message, a presentation document, a spreadsheet, a media player file, a webpage and a blog.

A user 205 may be interested in a particular content item 215 in one of the documents of the user session. For example, in a user session involving a media player application, a user listening to a soundtrack may be interested in learning more about a particular performer on the soundtrack. In another instance, in a user session involving a journal article, a second user may be interested in learning more about a company mentioned in the article. The user 205 may indicate an interest in a particular content item 215 of a user session by selecting the content item 215 within the file or document of the user session. For instance, the user in the media player example cited above could right click on the name of the performer on the soundtrack, while the second user may highlight the name of the company mentioned in the journal article example. The indication that a user in interested in a particular content item 215 within a user session may be received by receiving component 217 of the user computing device 210. Receiving component 217 of the user device 210 may also receive an indication that a user 205 wishes to request a content-aware search.

Upon selection of a particular content item 215 within a user session, user 205 may request a context-aware search by selecting context-aware search selector 220. Context-aware search selector 220 may be a hardware-based search selector associated with computing device 210, a software-based search selector, or a combination of a hardware-based and a software-based search selector. By way of example, a user 205 may right click a content item 215 to open a list of menu items including an item for initiating a context-aware search. In another example, a user may select a context-aware icon in a toolbar associated with the application of the user session. In another example, context-aware search selector may include a single hardware button, such as a shortcut key, that when selected provides an indication to search engine 240 that a context-aware search is desired.

A selection of context-aware search selector 220 within a particular user session may trigger the context analyzer component 225 of user computing device 210. The context analyzer component 225 analyzes the document or file associated with the user session to derive the contextual background of the document and generate contextual indicators for the particular user session. The context analyzer 225 may analyze a document of a user session by using a word extraction algorithm to extract important representative words in the document associated with the user session. The representative words of the document may be determined by comparing the frequency with which a word appears in the user session document to the frequency of occurrence of the word in a particular language. If a certain word occurs in the document above a predetermined frequency of occurrence of the word in common usage, the word is flagged as a potential representing word for the user session. Factors other than the frequency of occurrence may be used to derive contextual indicators from a document of a user session. By way of example only, particular words, for instance words such as “travel” and “purchase” or trademarked words may be designated as being representative regardless of their frequency in the document. Context analyzer component 225 may further analyze the extracted representative words of the user session document to determine high level contextual information. For example, in a user session document containing a flagged representative keyword such a “travel” and a high frequency of the word “France”, context analyzer component 225 may process the extracted words to determine that the contextual background of the document relates to travel to/or around France.

The approach of context analyzer component 225 to derive contextual information may vary based on the specific environment in which context analyzer operates. The environment in which context analyzer 225 is implemented depends on the characteristics of the document or filed associated with the user session. For instance, different rules may be used by context analyzer 225 to derive contextual information from an electronic mail message versus a spreadsheet or a media player file. In addition, the contextual indicators derived from a particular section of a document or file may be determined by context analyzer 225 to be of greater importance than those derived from other sections of the document. By way of example, contextual indicators derived from the subject line of an electronic mail message may be deemed more significant than contextual indicators derived from the body of the message. In another example, contextual indicators derived from the abstract of a journal article may be more significant than contextual indicators derived from the history section of the document.

The contextual indicators derived by context analyzer 225 may be provided for output in association with the user session of the computing device 210 by delivery component 227. In an embodiment of the present invention, user computing device 210 may include a mapping component 230. As previously indicated, some embodiments of system 200 may include a plurality of user devices 210, such as thousands or millions of user computing devices 210 connected to network 235. As such, in these instances, providing personalized contextual indicators from each user device 210 to search engine 240 could severely limit the ability of search engine 240 to efficiently provide search results from a search engine cache. Mapping component 230 enables search optimization and caching by limiting the variations of contextual indicators provided to search engine 240 by different user devices 210. Mapping component 230 maps the specific contextual indicators of a user session into predefined affinity groups. Predefined affinity groups refer to a subset of contextual indicators commonly derived from a plurality of users. By mapping the user session specific contextual indicators into categorical subsets of contextual indicators, mapping component 240 limits the variations per user session sent to the search engine by sending the mapped affinity group indicators as contextual hints to the search engine 240, thereby allowing the search engine to provide semi-personalized context-aware results from the cache of the search engine 240.

The search engine server 240 includes any computing device, such as the computing device 110, and provides at least a portion of the functionalities for providing a context-aware search engine. In an embodiment, a group of search engine servers 240 share or distribute the functionalities required to provide search engine operations to a user population. A search engine in accordance with embodiments of the present invention may provide relevant search results by using context data derived from user computing device 210 to identify search results that the user 205 has an increased likelihood (relative to the current context surrounding the user session from which the search is initiated) of desiring to access.

Search engine 240 may include various components such as receiving component 245, searching component 250, relevance component 255 and delivery component 260. Receiving component 245, may receive a search query from a user session on a user computing device 210. The search query may include keywords selected by user 205 from content items 215 of a user session. The search query may also include user-input search query terms. Receiving component 245 of the search engine may also receive contextual indicators derived from a content item 215 of a user session occurring on user computing device 210. By way of example, the contextual indicators may be received at the back end of search engine 240, and used by relevance component 255 to refine the search results using the contextual indicators derived from the user session.

Searching component 250 of the search engine searches for content responsive to the search query received by receiving component 245 by searching a search index or if applicable the cache of search engine 240. By way of example, a searching component 250 may perform a search in response to a search query by indentifying at least one content item (in the search engine index or cache) matching the search query. Upon receiving a set of search results generally responsive to the search query, relevance component 255 of search engine 240 determines the contextual relevance of one or more of the search results utilizing various relevance algorithms. By way of example, relevance component 255 of search engine 240 may determine the contextual relevance of the search results by ranking the search results utilizing at least a portion of the contextual indicators received from the user session from which the search query has been initiated. As such, the contextual indicators derived from a user session may be fed as hits to a search engine performing a context aware search to focus (via relevance component 255) the search results to those results that are contextually relevant based on the contextual indicators of user session. Relevance component 255 may also rank the set of search results based at least in part on the contextual relevance of each search result within the set of search results.

Delivery component 260 of search engine 240 provides search results in order of contextual relevance to the user 205 requesting the search within the user session, with those results deemed most relevant being provided to the user 205 first. For instance, search results having a contextual relevance above a pre-determined threshold may be delivered first to the user 205 requesting the search within the user session. By way of example, the top five search results ranked in order of highest contextual relevance may be immediately delivered to a user while search results with a low contextual relevance may be provided further down in the list of search results.

In another embodiment of the present invention, contextual indicators are derived from a user session on user computing device 210 and sent to a website 270 coupled with a data store 265 via network 235. By way of example only, if a user 205 transitions from a user session involving a word processing document to a website related to travel, contextual indicators derived from the word processing document may be provided to the website and used as hints by the website to determine which parts of the content of the website are more relevant to the user.

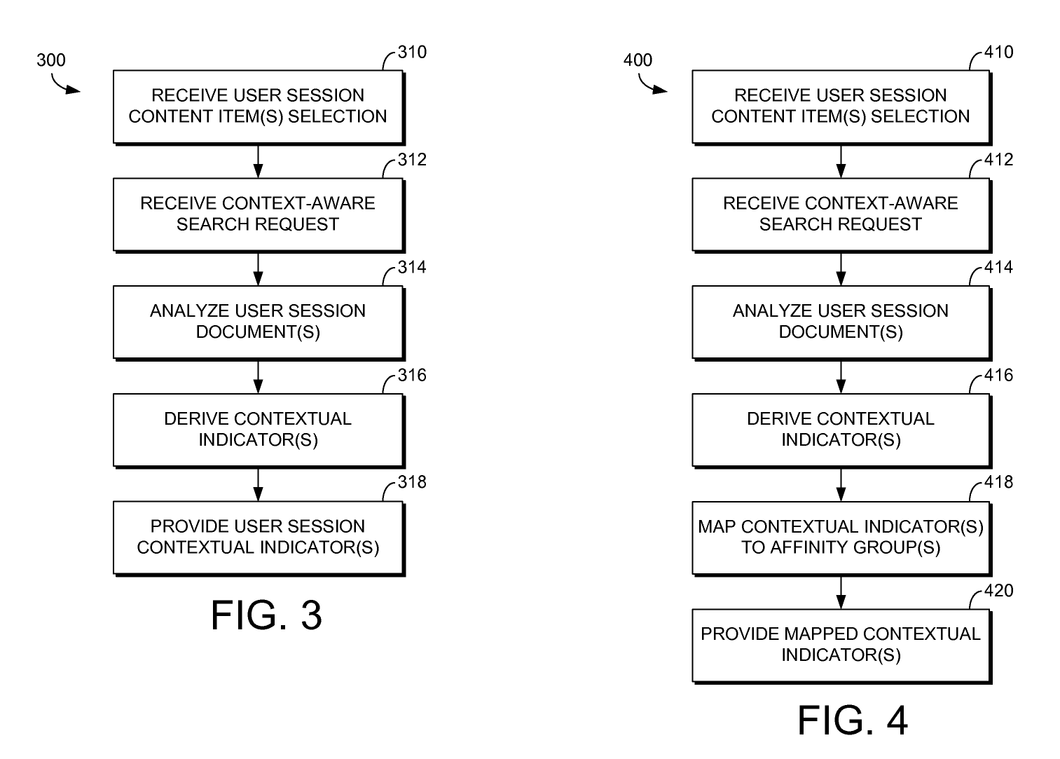

Turning now to FIG. 3, a flow diagram is illustrated showing a method 300 for providing contextual indicators associated with a user session, in accordance with an embodiment of the present invention. As shown at block 310, an indication that at least one content item has been selected within a user session is received, for instance, by a receiving component 217 of the user computing device 210 of FIG. 2. A user may indicate an interest in a particular content item of a user session by selecting the content item within the file or document of the user session. As shown at block 312, an indication that a context-aware search based on the one or more selected content items has been requested within the user session is received, for instance, by a receiving component 217 of the user computing device 210 of FIG. 2. Such indication may be received, for instance, upon a user selecting the selectable context-aware search selector 220 of FIG. 2. As shown at block 314, a document or file associated with the user session from which the context-aware search is requested is analyzed, for instance, by context analyzer 225 of FIG. 2. One or more contextual indicators indicative of relevant content of the document associated with the user session are derived, for instance by context analyzer 225 of FIG. 2, as indicated at block 316. The contextual indicators derived from the document associated with the current user session are provided for output in association with the user computing device, for instance, by delivery component 227 of user computing device 210 of FIG. 2, as indicated at block 318.

With reference to FIG. 4, a flow diagram is illustrated showing another method 400 for providing contextual indicators associated with a user session, in accordance with an embodiment of the present invention. As shown at block 410, an indication that at least one content item has been selected within a user session is received, for instance, by a receiving component 217 of the user computing device 210 of FIG. 2. A user may indicate an interest in a particular content item of a user session by selecting the content item within the file or document of the user session. Alternatively, by not selecting specific content or keywords within a document of the user session, the user may indicate an interest in a general search in the context of the document. As shown at block 412, an indication that a context-aware search based on the one or more selected content items has been requested within the user session is received, for instance, by a receiving component 217 of the user computing device 210 of FIG. 2. Such indication may be received, for instance, upon a user selecting the selectable context-aware search selector 220 of FIG. 2. As shown at block 414, a document or file associated with the user session from which the context-aware search is requested is analyzed, for instance, by context analyzer 225 of FIG. 2. One or more contextual indicators indicative of relevant content of the document associated with the user session are derived, for instance by context analyzer 225 of FIG. 2, as indicated at block 416. As shown at block 418, the contextual indicators derived from the document associated with the current user session may mapped into predefined affinity groups, for instance by mapping component 230 of the user computing device 210 of FIG. 2. The contextual indicators mapped into categorical subsets of contextual indicators are provided for output in association with the user computing device, for instance, by delivery component 227 of user computing device 210 of FIG. 2, as indicated at block 420.

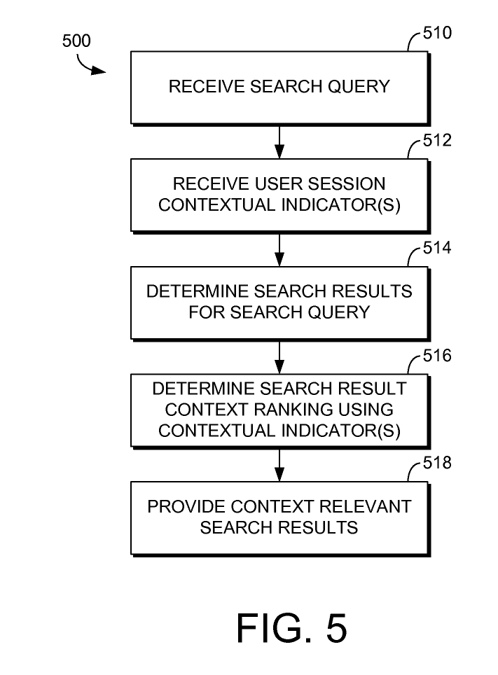

With reference to FIG. 5, a flow diagram is illustrated showing a method 500, for performing a context-aware search using contextual indicators associated with a user session, in accordance with an embodiment of the present invention. As shown at block 510, a search query is received, for instance, by receiving component 245 of the search engine 240 of FIG. 2. By way of example, the search query may comprise, content items such as keywords selected from a document associated with an interaction between a user and a particular application in a current user session. Alternatively, the search query may include a user-input search query term. As shown at block 512, one or more contextual indicators derived from the user session from which the search query is initiated are received, for instance, by receiving component 245 of the search engine 240 of FIG. 2. As shown at block 514, a set of search results based on the search query are determined, for instance, by searching component 250 of the search engine 240 of FIG. 2. The set of search results may include content items identified in the search engine index or search engine cache that match the search query. As shown at block 516, the search results may be ranked based according how relevant the search result may be to a user based on the contextual indicators derived from the user session, for instance, by relevance component 255 of the search engine 240 of FIG. 2. The contextual relevance of the search results may be determined by comparing the search results to at least a portion of the contextual indicators received from the user session from which the search query has been initiated. Search results more closely related to the contextual indicators receive a higher contextual relevance rank that result having a tenuous relation to the contextual indicator derived from the user session. As shown at block 518, search results determined to be contextually relevant to a user initiating the search query based upon the contextual indicators of the user session are provided, for instance, by delivery component 260 of the search engine 240 of FIG. 2.

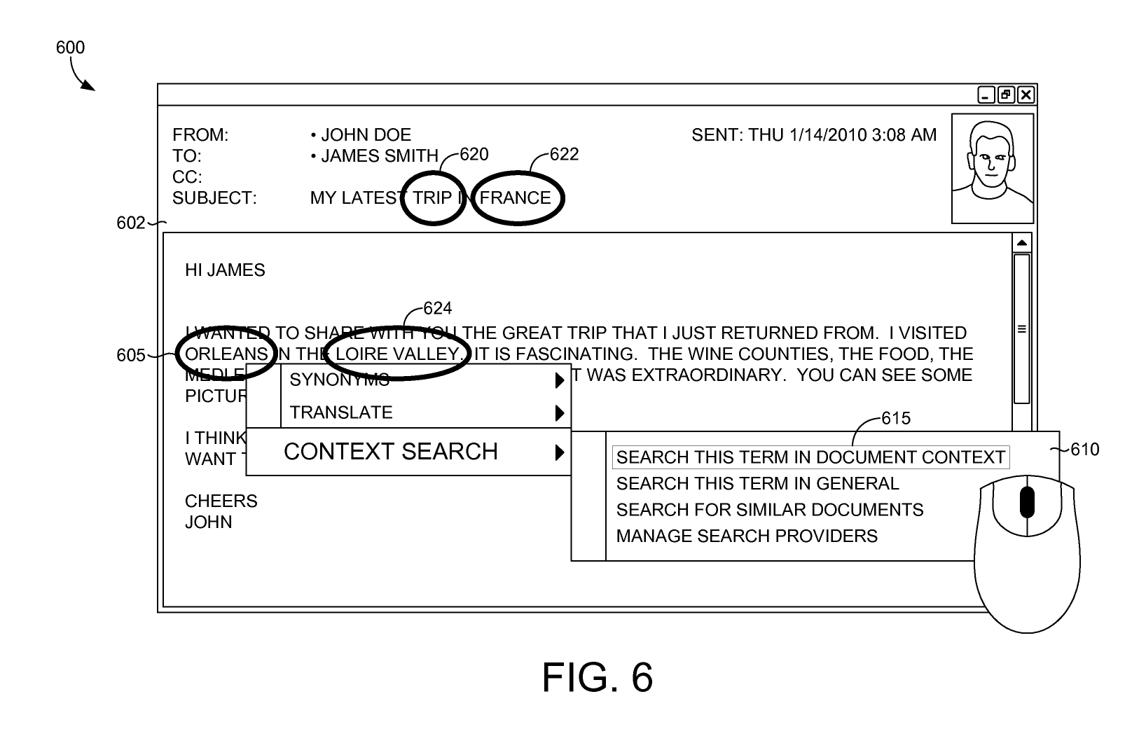

Turning now to FIG. 6, a line drawn representation of a graphical image 600, depicting contextual indicators derived in a user session in accordance with an embodiment of the invention. In user session involving a electronic mail message 602, a user indicates interest in content item 605 of the electronic mail message. By way of example only, the user may indicate an interest in content item 605 by highlighting the content item. The user may also indicate an interest in performing a context-aware search related to selected content item 605. The context-aware search may be request by accessing a menu 610 of required tasks. A task for performing a content-aware search 615 may be present in the listed items of menu 610. Upon selecting menu item 615 requesting a context search, contextual information is derived from the electronic mail message, for instance by context analyzer 225 of FIG. 2. Contextual indicators 620, 622 and 624 may be derived from the electronic mail message 602. Contextual indicators 620 and 622 derived from the subject line of electronic mail message 602 may be deemed more significant than contextual indicator 624 derived from the body of the message. Selected content item 605 may constitute the search query keyword provided to a search engine. In addition, contextual indicators 620, 622 and 622 may be used to focus the search results to obtain results relevant to the context of the keyword 605 in the email message 602 associated with the user session from which the search request is initiated. The search results may be presented to the user either inside the email application or in a separate user-interface associated with the search engine.

In certain embodiments, no specific content items are selected within a document of a user session. When a context aware search is initiated in these instances, no specific search keywords are sent to the search engine. Instead, the derived contextual indicators are appended to user-input search query terms entered into the search engine. In other embodiments, a search for similar documents to the document of the user session may be initiated by performing a context-aware search where the contextual indicators are used as search keywords by the search engine. In other embodiments, contextual information may be derived from activities beyond the current user session. For instance, contextual indicators may be derived from documents associated with the multiple user sessions of a user, these contextual indicators may be associated with a user profile reflecting the long term intent of the user. The contextual indicators of the user profile may in turn be provided to a search engine or website to produce relevant content based on the overall context of the user.

While the invention is susceptible to various modifications and alternative constructions, certain illustrated embodiments thereof are shown in the drawings and have been described above in detail. It should be understood, however, that there is no intention to limit the invention to the specific forms disclosed, but on the contrary, the intention is to cover all modifications, alternative constructions, and equivalents falling within the spirit and scope of the invention.

It will be understood by those of ordinary skill in the art that the order of steps shown in the method 300 of FIG. 3, the method 400 of FIG. 4 and the method 500 of FIG. 500 are not meant to limit the scope of the present invention in any way and, in fact, the steps may occur in a variety of different sequences within embodiments hereof. For instance, contextual indicators may be received subsequent to receiving a request for a context-aware search, within the scope of embodiments hereof. Any and all such variations, and any combination thereof, are contemplated to be within the scope of embodiments of the present invention.

The present invention has been described in relation to particular embodiments, which are intended in all respects to be illustrative rather than restrictive. Alternative embodiments will become apparent to those of ordinary skill in the art to which the present invention pertains without departing from its scope.

What is claimed is:

1. One or more computer storage media having computer-executable instructions embodied thereon, that when executed, cause a computing device to perform a method for providing contextual indicators associated with a user session, the method comprising:
receiving an indication that one or more content items have been selected within a user session, the user session being an in progress encounter between a user and at least one application;
receiving an indication that a context-aware search based on the one or more selected content items has been requested within the user session;
analyzing at least one document associated with the user session for contextual information related to the one or more selected content items;
deriving one or more contextual indicators from the at least one document, the one or more contextual indicators being keywords that represent relevant content of the at least one document associated with the user session; and
providing the one or more derived contextual indicators for output in association with the user session of the computing device generating a context-aware search request.

2. The one or more computer storage media of claim 1, wherein the one or more content items within a user session comprises, at least in part, user-selected keywords contained by the at least one document associated with the user session.

3. The one or more computer storage media of claim 1, wherein the one or more content items within a user session comprises the at least one document associated with the user session.

4. The one or more computer storage media of claim 1, wherein receiving the indication that the context-aware search has been requested comprises receiving an indication that a context-aware search selector has been selected.

5. The one or more computer storage media of claim 3, wherein the context-aware search selector is one of a hardware-based search selector associated with the computing device, a software-based search selector, and a combination of a hardware-based and a software-based search selector.

6. The one or more computer storage media of claim 1, wherein the at least one document associated with the user session is one of, a word processing document, an electronic mail message, an instant message, a presentation document, a spreadsheet, a media player file, a webpage and a blog.

7. The one or more computer storage media of claim 1, wherein analyzing at least one document associated with the user session for contextual information related to the one or more content items comprises:
extracting one or more representative words from the at least one document, wherein the one or more representative words appear in the at least one document above a predetermined frequency of occurrence of the one or more representative words in common usage; and
using the extracted one or more representative words to determine high level contextual information.

8. The one or more computer storage media of claim 1, wherein the method further comprises mapping the derived one or more contextual indicators from the at least one document within the user session into at least one predefined affinity group, the at least one predefined affinity group being a set of contextual indicators commonly derived from a plurality of users.

9. The one or more computer storage media of claim 1, wherein providing the one or more derived contextual indicators for output in association with the user session of the computing device generating a context-aware search request comprises sending the one or more derived contextual indicators to one of a search engine, or a website.

10. One or more computer storage media having computer-executable instructions embodied thereon, that when executed, cause a computing device to perform a method for performing a context-aware search using contextual indicators associated with a user session, the method comprising:
receiving a search query;
receiving one or more contextual indicators derived from the user session from which the search query has been initiated, the user session being an in progress encounter between a user and at least one application, wherein the one or more contextual indicators comprise keywords that represent relevant content of at least one document associated with the user session;
determining a set of search results based on the search query; and
determining for at least one search result a contextual relevance by comparing the at least one search result to at least a portion of the one or more contextual indicators derived from the user session from which the search query has been initiated.

11. The one or more computer storage media of claim 10, wherein the method further comprises ranking the set of search results based at least in part on the contextual relevance of each search result within the set of search results.

12. The one or more computer storage media of claim 11, wherein the method further comprises communicating at least a subset of the search results to a user initiating the search query, the subset of search results having a contextual relevance above a pre-determined threshold.

13. The one or more computer storage media of claim 10, wherein the search query comprises user-selected keywords contained by the at least one document associated with the user session.

14. The one or more computer storage media of claim 10, wherein the search query comprises one or more contextual indicators derived from the user session from which the search query has been initiated.

15. The one or more computer storage media of claim 10, wherein the at least one document associated with the user session is one of, a word processing document, an electronic mail message, an instant message, a presentation document, a spreadsheet, a media player file, a webpage and a blog.

16. A computerized system for performing a context-aware search using contextual indicators associated with a user session, the system comprising:
a processing unit; and
a memory for storing computer-executable instructions that when executed by the processing unit executes:
a context-aware search selector component configured to provide an indication that the context-aware search has been requested within the user session;
a context analyzer component configured to analyze at least one document associated with the user session for contextual information and to derive one or more contextual indicators from the at least one document, the one or more contextual indicators being keywords that represent relevant content of the at least one document associated with the user session;
a searching component configured to perform a search in response to a search query by indentifying at least one content item matching the search query;
a relevance component configured to determine for the at least one content item matching the search query a contextual relevance to the user requesting the search, the contextual relevance being determined by ranking the at least one content item matching the search query utilizing the one or more contextual indicators associated with the user session; and
a delivery component configured to provide search results having a contextual relevance above a pre-determined threshold to the user requesting the search within the user session.

17. The system of claim 16, wherein the user session comprises an in progress encounter between the user and at least one application.

18. The system of claim 16, wherein the user session comprises multiple activities between the user and a plurality of applications.

19. The system of claim 16, further comprising a mapping component configured for mapping the derived one or more contextual indicators from the at least one document within the user session into at least one predefined affinity group, the at least one predefined affinity group being a set of contextual indicators commonly derived from a plurality of users.

20. The system of claim 16, wherein the at least one document associated with the user session is one of, a word processing document, an electronic mail message, an instant message, a presentation document, a spreadsheet, a media player file, a webpage and a blog.
